(19) United States
(12) Patent Application Publication
(10) Pub. No.: US 2012/0251426 A1
(43) Pub. Date: Oct. 4, 2012

(54) Polycrystalline Silicon For Solar Cell And Preparation Method Thereof

(75) Inventor: Kenji Sato, Kamisu-shi (JP)

(73) Assignees: JX NIPPON MINING & METALS CORPORATION, Chiyoda-ku, Tokyo (JP); JNC CORPORATION, Chiyoda-ku, Tokyo (JP); TOHO TITANIUM CO., LTD., Chigasaki-shi, Kanagawa (JP)

(21) Appl. No.: 13/515,426

(22) PCT Filed: Oct. 20, 2010
(86) PCT No.: PCT/JP10/68511

§ 371 Date: Jun. 12, 2012

(30) Foreign Application Priority Data
Dec. 14, 2009 (JP) 2009-283002

(51) Int. Cl. C01B 33/021; C01B 33/02

(52) U.S. Cl. 423/348; 65/26

(57) ABSTRACT

The present invention provides a process for preparing a polycrystalline silicon having the surface layer in which the areas having a short carrier lifetime due to Fe has been substantially eliminated. A preparation method of polycrystalline silicon comprising preparing a mold evenly applied with a mold release agent produced by mixing a binder and a solvent with a silicon nitride powder and then solidifying a molten silicon in said mold, wherein x≦5.0, 20≦y≦100 and x×y≦100 are satisfied given that x represents a concentration of Fe (atomic ppm) contained as impurity in the silicon nitride powder and y represents a thickness of the mold release agent (μm) applied to the mold.

### TECHNICAL FIELD

The present invention relates to polycrystalline silicon for solar cell and preparation method thereof.

### BACKGROUND ART

Solar cell is a kind of semiconductors which can directly transform the light energy into electricity. It is promising as a clean method for electricity generation since it can generate electricity without discharging carbon dioxide which causes global warming as well as harmful exhaust gases, and thus, it has begun to be popularized as a power supply for ordinary households. While the solar batteries can be classified into several kinds according to the semiconductor used as a base, they can be classified broadly into silicon type and compound type. At present, the majority of solar batteries supplied in the market is the silicon type. While the silicon type solar batteries can be further classified into a single crystalline type and a polycrystalline type, the latter is major because it is advantageous to reduce the cost.

As one of the preparing method of polycrystalline silicon, a cast method in which a molten silicon is grown and solidified in a mold is known. As a mold, quartz crucible and graphite crucible are used. During this process, a mold release agent made of silicon nitride (Si₃N₄) is generally applied to the inside of the mold for the purpose of preventing adhesion of silicon to the mold and preventing cracks in silicon by thermal stress during solidification.

By the way, since impurities included in the polycrystalline affect adversely on the cell performance such as the conversion efficiency even when the amount of impurities is infinitesimal, a high purity of 6N or more is generally required for silicon. Accordingly, it is desired to use a mold release agent of high purity with little impurities so that a very small amount of impurities such as Fe, C, Al and Ca contained in the agent would not diffuse into the silicon during the preparation process of the polycrystalline silicon and decrease the purity of the silicon. Among the impurities, as Fe has a big diffusion constant into silicon, it is especially desired to be certainly removed from the mold release agent.

Accordingly, Japanese Patent Application Publication No. 2007-261832 (Patent document 1) discloses that Fe concentration in a powdery mold release agent of silicon nitride can be decreased to 20 ppm or less by subjecting the mixture prepared by adding water to the powdery mold release agent to a repeated process of kneading in a ball mill and stirring with a magnetic stirrer coated with Teflon (Registered Trademark). It is described, in working example, that Fe concentration was decreased to 5 ppm.

### PRIOR ART DOCUMENTS

### Patent Documents

### [Patent Document 1]

Japanese Patent Application Publication No. 2007-261832

### SUMMARY OF THE INVENTION

### Problem to be Solved by the Invention

However, the present inventors have revealed that decrease of Fe concentration in the mold release agent made of silicon nitride to about 5 ppm was not enough and Fe sill diffuses from the mold release agent to the silicon side during growth of polycrystalline silicon and areas having a short carrier lifetime are formed on the surface layer of the silicon. Since carrier lifetime is directly linked to the conversion efficiency of solar cell, it is desirable for the polycrystalline silicon to have a long carrier lifetime in order to obtain a high conversion efficiency. Further, when the surface layer having a short carrier lifetime is scraped away as remnants, there arises a problem that a yield rate will decrease.

Accordingly, one of the problems to be solved by the present invention is to provide a polycrystalline silicon having the surface layer in which the areas having a short carrier lifetime due to Fe, has been substantially eliminated. Another problem to be solved by the present invention is to provide a process for preparing such a polycrystalline silicon.

### Means for Solving Problem

The present inventors have eagerly studied in order to solve the problem and found that simply controlling the Fe concentration in the mold release agent is not sufficient, and controlling, in addition, the thickness of the mold release agent applied to the mold is important, and only after the Fe concentration in the mold release agent made of silicon nitride and the thickness of the mold release agent applied to the mold satisfy a given condition, the areas in the surface layer having a short lifetime due to Fe substantially disappear.

Specifically, given that silicon nitride is used as a mold release agent and a Fe concentration in the mold release agent is represented by x (atomic ppm)and a thickness of the mold release agent applied to the mold is represented by y (μm), we have found that the areas having a good lifetime are rapidly expanded by preparing the polycrystalline silicon in a mold coated with the mold release agent under the condition of x≦5.0, 20≦y≦100 and x×y≦100. Polycrystalline silicon obtained by said process has a Fe concentration of not more than 1 atomic ppm, typically not more than the detection limit (not more than 10 ppb) at the top of surface which has not yet been polished. When the Fe concentration is not more than 1 atomic ppm, a bad influence by Fe on lifetime is negligible (K. A. Yamakawa, “The Effect of Impurities on the Performance of Silicon Solar Cells”, JPL Publication, Sep. 1, 1981). When the Fe concentration at the top of the surface is not more than 1 atomic ppm, the Fe concentration inside thereof becomes lower according to the principle of diffusion.

Accordingly, in one aspect, the present invention provides a preparation method of a polycrystalline silicon comprising preparing a mold applied with a mold release agent produced by mixing a binder and a solvent with a silicon nitride powder and then solidifying a molten silicon in said mold, wherein x≦5.0, 20≦y≦100 and x×y≦100 are satisfied given that x represents a concentration of Fe (atomic ppm) contained as impurity in the silicon nitride powder and y represents a thickness of the mold release agent (μm) applied to the mold.

In one embodiment of the preparation method of the polycrystalline silicon according to the present invention, the concentration of Fe in the silicon nitride powder has been reduced through a process in which hydrochloric acid or aqua regia is contacted with the silicon nitride powder, said process being performed in ultrasonic waves and/or in a grinder using grinding medium made of other than Fe.

In another embodiment of the preparation method of the polycrystalline silicon according to the present invention, x≦1.0.

In yet another embodiment of the preparation method of the polycrystalline silicon according to the present invention, 30≦y≦80.

In one embodiment of the preparation method of the polycrystalline silicon according to the present invention, x×y≦30.

In yet another embodiment of the preparation method of the polycrystalline silicon according to the present invention, the temperature of hydrochloric acid or aqua regia is 60-100° C.

In another aspect, the present invention provides a polycrystalline silicon having a carrier lifetime of 5 μsec or more at a crystal surface contacted with a mold release agent.

### Effect of the Invention

According to the present invention, a polycrystalline silicon having the surface layer in which the areas having a short carrier lifetime due to Fe has been substantially eliminated can be obtained, resulting in good yield rate of silicon material and production of a solar cell having a high conversion efficiency.

### MODES FOR CARRYING OUT THE INVENTION

### 1. Preparation of the Mold Release Agent

It is possible to prepare the mold release agent used in the present invention by mixing silicon nitride powder as a material in a solution of a binder and a solvent until the mixture becomes a slurry. However, a commercially available silicon nitride powder contains a high concentration of Fe (typically, 10 ppm or more), and therefore, it cannot be directly used in the present invention. Accordingly, first of all, it is necessary to reduce Fe concentration in the silicon nitride powder.

As for a method for reducing the concentration of Fe in silicon nitride powder, the patent document 1 describes a method in which water is added to the silicon nitride powder to obtain a mixture and then kneading the mixture in a ball mill and stirring with a Teflon (registered trademark) coated magnetic stirrer are repeated. However, it is not sufficient. Even if it is possible, the steps and time required for achieving such concentration will be prolonged.

Therefore, in the present invention, in order to reduce the concentration of Fe in the silicon nitride powder efficiently, hydrochloric acid or aqua regia which can effectively dissolve iron is brought into contact with the silicon nitride powder. Further, said contact is performed in the ultrasonic waves and/or in a grinder such as a ball mill, a vibration mill and the like using grinding medium made of other than Fe. Employing such constitution makes it possible to reduce the concentration of Fe to the desired level within a shorter time. As stirring with ultrasonic waves and kneading in a ball mill are used together, coagulation of silicon nitride powder is easily solved, and therefore, contact efficiency of Fe component mixed in the silicon nitride powder with acid increases, resulting in an efficient elution of Fe. The smaller the particle size of the silicon nitride powder used is, the higher the contact efficiency is, and therefore, for example, median particle diameter (d50) of not more than 1 μm is desirable.

When a ball mill is used, it is preferable to use grinding medium made of other than Fe for preventing secondary contamination. For example, a ball made of resin such as Nylon, PVC, PP, PE, ABS and the like or silicon nitride can be used. Resin has a prohibiting effect against the secondary contamination since, even if a resin component is mixed into the silicon nitride powder, the resin component is volatilized in the subsequent annealing process. On the other hand, the ultrasonic waves are superior to the ball mill in that it can be used with no anxiety of secondary contamination. The ultrasonic waves and ball mill can be used independently or they can be used in combination. The time required for dissolving Fe from the silicon nitride powder can be appropriately set according to the targeted Fe concentration.

Hydrochloric acid or aqua regia may be used at room temperature (15-25° C.). However, using as a heated aqueous solution at around 60-100° C., preferably 80-100° C. is desirable from the point of view of solubility of Fe. As for the concentration of acid in the aqueous solution, 2-30 mass %, preferably 5-20 mass % is desirable, in case of hydrochloric acid, for dissolving Fe efficiently. The reason why the upper limit is defined is that the dissolving rate decreases when the concentration is too high.

After the silicon nitride powder was brought into contact with acid as described above, it is desirable to perform the washing with ultrapure water in order to minimize the erosion of annealing furnace during the subsequent annealing process and the contamination by the erosion. The targeted Fe concentration in the silicon nitride powder in the present invention is 5.0 atomic ppm or less after the end of the post-treatment. This is because more than 5.0 atomic ppm of the Fe concentration in the silicon nitride powder will unavoidably generate the areas having a short lifetime in the surface layer of silicon due to the diffusion of Fe even if the thickness of the mold release agent applied to the mold is thin. Further, the mold release agent having too thin a thickness will not function as a mold release agent as it should do. The Fe concentration in the silicon nitride powder is preferably 3.0 atomic ppm or less, more preferably 1.0 atomic ppm or less, and yet more preferably 0.5 atomic ppm or less.

After the post-treatment of the silicon nitride powder, the mold release agent is prepared by mixing the silicon nitride powder with conventional binder and solvent. Examples of the binder include, but not limited to, PVA (polyvinyl alcohol), PVB (polyvinyl butyral), MC (methyl cellulose), CMC (carboxymethyl cellulose), EC (ethyl cellulose), HPC (hydroxypropyl cellulose), waxes and starch. Among them, PVA is preferable in terms of purity and adequate viscosity at the time when it is applied. Examples of the solvent includes, but not limited to, water and alcohol. Among them, water is preferable in terms of easy handling. The blend ratio of silicon nitride powder, binder and solvent is not particularly limited. It can be appropriately set considering the viscosity at the time when it is applied. As an example, 100 g of binder and 100 g of solvent may be used per 100 g of silicon nitride powder.

### 2. Application of the Mold Release Agent to the Mold

After preparation of the mold release agent, the mold release agent is applied to the inner surface of the mold having appropriate shape and size. The mold release agent is preferably applied with a uniform thickness. As for the mold, while it is not particularly limited, a quartz crucible and graphite crucible can be used in general. The mold release agent can be applied using spray, spatula or brush, though not particularly limited thereto. When the thickness of the mold release agent applied to the mold is too thin, it does not function as a mold release agent. On the contrary, when it is too thick, it is easily come off from the mold. Accordingly, it is necessary to apply the mold release agent to the mold at the thickness of 20-100 μm, preferably 30-80 μm.

In the present invention, it is further important to apply the mold release agent under the condition of x×y≦100, given that the Fe concentration in the silicon nitride powder used in the mold release agent is x (atomic ppm) and the thickness of the mold release agent applied to the mold is y (μm). When x×y>100, a bad influence on the lifetime occurs due to diffusion of Fe from the mold release agent into silicon. On the contrary, when x×y≦100, the areas where the lifetime is good rapidly increase. It is important to control the thickness of the mold release agent together with reduction of the Fe concentration in the silicon nitride powder. x×y≦50 is preferable, x×y≦30 is more preferable, and x×y≦20 is yet more preferable.

After the mold release agent is applied to the mold, the mold is annealed for removing the solvent and binder. This anneal can be performed according to any method known to those skilled in the art. For example, it can be performed by heating the mold in the atmosphere to 850-950° C., and holding at said temperature for 3-5 hours, and then cooling the mold. The solvent and binder are evaporated or thermally decomposed by the high-temperature upon heating and thus removed from the mold release agent.

### 3. Preparation of Polycrystalline Silicon

As for the method for preparing the polycrystalline silicon using the mold obtained as described above, a cast process in which a highly purified silicon is molten and poured into the mold, and the polycrystalline silicon is allowed to grow and solidified in the mold can be mentioned, though not particularly limited thereto. As a method for obtaining a highly purified silicon, for example, Siemens method is known. According to this method, metal silicon raw material of purity of about 97% is chlorinated, and then purified and reduced so that a highly purified silicon, at least 11 N, is obtained. The polycrystalline silicon can be grown by putting the raw material into a crucible and performing unidirectional solidification from the bottom of the crucible. Specifically, the molten sample is solidified sequentially from the bottom of the crucible unidirectionally by moving the mold containing the molten silicon in the furnace having an appropriate gradient of temperature or decreasing the temperature of the furnace keeping an appropriate gradient of temperature.

As for the polycrystalline silicon according to the present invention, the decrease of the lifetime at the surface layer due to impurity Fe contained in the mold release agent is substantially eliminated, and therefore, the areas where the lifetime is good are expanded dramatically. Specifically, while, in the prior art, there were the areas where the lifetime is 1 μsec or less at the position about 2 cm distant from the contact surface of the polycrystalline silicon with the mold release agent, the areas where the lifetime is 5 μsec or more can be typically obtained even at the contact surface of the polycrystalline silicon with the mold release agent according to the present invention.

### 4. Measuring Method

Various characteristic values used in the present invention are measured by using the following methods.

The Fe concentration in the silicon nitride powder used for the mold release agent is measured by ICP-MS in accordance with JISK0133-2007. In the examples, ICP-MS type 7500CS from Agilent Co. was used.

The thickness of the mold release agent applied to the mold is determined by measuring the weight of the mold before application of the mold release agent and the weight of the mold after application of the mold release agent and evaporation of the solvent and binder to calculate the weight of the silicon nitride applied, and then using the calculating formula:

Weight of silicon nitride applied (g)/3.44 (g/cm³)/Surface area (cm²) of inner surface area of the crucible.

The lifetime of silicon is measured by a chemical passivation method using iodine. The procedure of the measurement is as follows. The grown crystal is wafered and then the surface of the wafer is lapped with #600 sandpaper, and then the surface is etched with hydrofluoric nitric acid to provide a mirror finished surface. The crystal is placed in a plastic bag and the bag is filled with iodine-methanol solution so that the solution is distributed thinly and almost evenly on the surface of the crystal. The measurement of the lifetime is performed by micro PCD method. WT2000 from SEMI LAB Co. was used. Specifically, the measurement was performed in accordance with the instruction described in SEMI MF1535-1106.

### EXAMPLE

The present invention will be explained as described below. However, the present invention is not limited to them.

### Example 1 (Comparative Example)

200 grams of silicon nitride powder (SN-E10 by Ube Industries, Ltd., specific surface area: 9-13 m²/g, Fe conc.<100 ppm, median particle diameter: about 0.5 μm) was prepared. When Fe concentration in said powder sample was determined, it was 10.0 atomic ppm. This was mixed with 200 mL of PVA and 200 mL of water to obtain a mold release agent in a slurry state in which silicon nitride was evenly dispersed. This mold release agent was applied evenly with a brush to the inner surface of a quartz crucible (GLASSUN by Covalent Materials Corporation, purity: 99 mass % (SiO₂), shape (inner dimension): width 190 mm×depth 190 mm×height 300 mm). Subsequently, the quartz crucible applied with the mold release agent was calcined in the atmosphere at 950° C. for 3 hours for removing PVA and water. At this stage, the thickness of the mold release agent applied to the quartz crucible was 50 μm.

Subsequently, 10 kg of high purity 11 N silicon produced by Siemens method was prepared. Into the quartz crucible applied with the mold release agent obtained as described above, chunk raw material of said silicon was charged. The crucible charged with the raw material was placed in Bridgman furnace and then silicon was completely molten by heating to 1500° C. in an argon atmosphere under reduced pressure, and then, unidirectional solidification was performed for producing the polycrystalline silicon. The growth rate was 10 mm/hr, growth time was 15 hours and cooling time was 12 hours. The polycrystalline silicon obtained was taken out and split lengthwise with a bandsaw. It was then lapped with #600 sandpaper before the surface was etched with hydrofluoric nitric acid. Subsequently, the in-plane measurement of lifetime was performed using the above-described passivation method with iodine, which showed that it was less than 1 μsec at the bottom portion and side portion contacted with the crucible.

### Example 2 (Comparative Example)

The silicon nitride powder was washed by immersing it in hydrochloric acid (10 mass %) at 20° C. and stirring it with a magnetic stirrer coated with Teflon (registered trademark) for 5 hours. It was then subjected to post-treatment by immersing it in an ultrapure water and removing the supernatant multiple times. After the treatment, the Fe concentration in the silicon nitride powder was 5.0 atomic ppm. A mold release agent was prepared in the same way as in Example 1 with the exception of said treatment. Further, application of the mold release agent to the quartz crucible and the production of the polycrystalline silicon were also performed under the same condition as in Example 1. As a result, the lifetime of silicon was less than 1 μsec.

### Example 3 (Comparative Example)

Preparation of the mold release agent, application of the mold release agent onto the quartz crucible and production of the polycrystalline silicon were performed under the same condition as in Example 1 with the exception that the thickness of the mold release agent applied to the quartz crucible was 20 μm. As a result, the lifetime of silicon was less than 1 μsec.

### Example 4 (Comparative Example)

Preparation of the mold release agent, application of the mold release agent to the quartz crucible and production of the polycrystalline silicon were performed under the same condition as in Example 2 with the exception that the thickness of the mold release agent applied to the quartz crucible was 10 μm. As a result, the crystal was firmly fixed to the crucible and cracks in the crystal were caused. It was not able to be estimated as a crystal.

### Example 5 (Comparative Example)

The Silicon nitride powder was washed for 1 hour by immersing it in hydrochloric acid (10 mass %) at 80° C. and stirring it with ultrasonic waves. Subsequently, the supernatant was removed and then washing with ultrapure water and removal of the supernatant were repeated five times. The Fe concentration in the silicon nitride powder after the treatment was 1.0 atomic ppm. With the exception of said treatment, the mold release agent was prepared in the same way as in Example 1. Further, with the exception that the thickness of the mold release agent applied to the quartz crucible was 200 μm, application of the mold release agent to the quartz crucible was performed under the same condition as in Example 1. As a result, the lifetime of the silicon was less than 1 μsec.

### Example 6 (Working Example of the Present Invention)

The Silicon nitride powder was washed for 1 hour by immersing it in hydrochloric acid (10 mass %) at 80° C. and stirring it with ultrasonic waves. Subsequently, the supernatant was removed and then washing with ultrapure water and removal of the supernatant were repeated five times. The Fe concentration in the silicon nitride powder after the treatment was 1.0 atomic ppm. With the exception of said treatment, the mold release agent was prepared in the same way as in Example 1. Further, with the exception that the thickness of the mold release agent applied to the quartz crucible was 100 μm, application of the mold release agent to the quartz crucible and preparation of polycrystalline silicon were performed under the same condition as in Example 1. As a result, the lifetime of the silicon at the portion contacted with the mold release agent was 5 μsec.

### Example 7 (Working Example of the Present Invention)

With the exception that the time for the stirring with ultrasonic waves was doubled, preparation of the mold release agent dispersion, application of the mold release agent to the quartz crucible and production of the polycrystalline silicon were performed under the same condition as in Example 6. As a result, Fe concentration in the silicon nitride powder was 0.5 atomic ppm, and the lifetime of the silicon at the portion contacted with the mold release agent was 25 μsec.

### Example 8 (Working Example of the Present Invention)

With the exception that the thickness of the mold release agent applied to the quartz crucible was 50 μm, preparation of the dispersion of the mold release agent, application of the mold release agent and growth of the polycrystalline silicon were performed in same way as in Example 6. As a result, the lifetime of the silicon at the portion contacted with the mold release agent was 25 μsec.

### Example 9 (Working Example of the Present Invention)

A mixture of 200 g of silicon nitride powder and 400 mL of hydrochloric acid (10 mass %) at 60° C. were kneaded in a ball mill (a nylon pot of Φ240 mm×H220 mm) containing 1200 nylon balls (Φ10 mm) for 3 hours at 72 rpm. Subsequently, filtration was performed with a Teflon (registered trademark) membrane. The silicon nitride powder after the filtration and 800 mL of ultrapure water were mixed and placed in a nylon pot, and then a washing treatment was performed for 30 minutes at 72 rpm. The process from the filtration to the washing with ultrapure water was repeated five times. The Fe concentration in the powder sample after the treatment was 2.0 atomic ppm. With the exception of said treatment, the mold release agent was prepared under the same condition as in Example 1. Further, With the exception that the thickness of the mold release agent applied to the quartz crucible was 50 μm, application of the mold release agent to the quartz crucible and production of the polycrystalline silicon were performed under the same condition as in Example 1. As a result, the lifetime of the silicon at the portion contacted with the mold release agent was 5 μsec.

### Example 10 (Working Example of the Present Invention)

A mixture of 200 g of silicon nitride powder and 400 mL of hydrochloric acid (10 mass %) at 60° C. were kneaded in a ball mill (a nylon pot of Φ240 mm×H220 mm) containing 1200 nylon balls (Φ10 mm) for 3 hours at 72 rpm. Subsequently, filtration was performed with a Teflon (registered trademark) membrane. The silicon nitride powder after the filtration and 800 mL of ultrapure water were mixed and placed in a nylon pot, and then a washing treatment was performed for 30 minutes at 72 rpm. The process from the filtration to the washing with ultrapure water was repeated five times. The silicon nitride treated as described above was further immersed in hydrochloric acid (10%) at 100° C. and washed with ultrasonic waves, and then the same post-treatment as described above (filtration and washing with ultrapure water was performed five times) was carried out. The Fe concentration in the silicon nitride powder obtained thereafter was 0.1 atomic ppm. With the exception of the conditions described above, the mold release agent dispersion was prepared in the same way as in Example 1. Further, with the exception that the mold release agent was applied to the quartz crucible so that the thickness of the agent would be 100 μm, application of the mold release agent to the quartz crucible and production of polycrystalline silicon were performed in the same way as in Example 1. As a result, the lifetime of the silicon at the portion contacted with the mold release agent was 150 μsec, this value being comparable to the lifetime of the internal portion of the crystal.

### Example 11 (Comparative Example)

A mixture of 200 g of silicon nitride powder and 400 mL of hydrochloric acid (10 mass %) at 60° C. were kneaded in a ball mill (a nylon pot of Φ240 mm×H220 mm) containing 1200 nylon balls (Φ10 mm) for 3 hours at 72 rpm. Subsequently, filtration was performed with a Teflon (registered trademark) membrane. The silicon nitride powder after the filtration and 800 mL of ultrapure water were mixed and placed in a nylon pot, and then a washing treatment was performed for 30 minutes at 72 rpm. The process from the filtration to the washing with ultrapure water was repeated five times. The Fe concentration in the powder sample after the treatment was 2.0 atomic ppm. With the exception of said treatment, the mold release agent was prepared under the same condition as in Example 1. Further, with the exception that the thickness of the mold release agent applied to the quartz crucible was 70 μm, application of the mold release agent to the quartz crucible and production of the polycrystalline silicon were performed under the same condition as in Example 1. As a result, the lifetime of the silicon at the portion contacted with the mold release agent was 1 μsec.

The results of the above-described examples are summarized in Table 1. It can be seen, from Table 1, that lifetime of polycrystalline silicon has been drastically improved in case where all of x≦5.0, 20≦y≦100, and x×y≦100 are satisfied.

TABLE 1

| | Fe conc. in | Thickness of | | |
|---|---|---|---|---|
| | mold release | mold release | | |
| | agent (x) | agent (y) | | |
| No. | (atomic ppm) | (μm) | x × y | Lifetime |
| 1 (Comp. Ex.) | 10.0 | 50 | 500 | <1 μsec |
| 2 (Comp. Ex.) | 5.0 | 50 | 250 | <1 μsec |
| 3 (Comp. Ex.) | 10.0 | 20 | 200 | <1 μsec |
| 4 (Comp. Ex.) | 5.0 | 10 | 50 | Crystal |
| | | | | growth |
| | | | | impossible |
| 5 (Comp. Ex.) | 1.0 | 200 | 200 | <1 μsec |
| 6 (Working. Ex.) | 1.0 | 100 | 100 | 5 μsec |
| 7 (Working. Ex.) | 0.5 | 100 | 50 | 25 μsec |
| 8 (Working. Ex.) | 1.0 | 50 | 50 | 25 μsec |
| 9 (Working. Ex.) | 2.0 | 50 | 100 | 5 μsec |
| 10 (Working. Ex.) | 0.1 | 100 | 10 | 150 μsec |
| 11 (Comp. Ex.) | 2.0 | 70 | 140 | 1 μsec |

1. A preparation method of a polycrystalline silicon comprising preparing a mold applied with a mold release agent produced by mixing a binder and a solvent with a silicon nitride powder and then solidifying a molten silicon in said mold, wherein x≦5.0, 20≦y≦100 and x×y≦100 are satisfied given that x represents a concentration of Fe (atomic ppm) contained as impurity in the silicon nitride powder and y represents a thickness of the mold release agent (μm) applied to the mold.

2. The preparation method according to claim 1, wherein the concentration of Fe in the silicon nitride powder has been reduced through a process in which hydrochloric acid or aqua regia is contacted with the silicon nitride powder, said process being performed in ultrasonic waves and/or in a grinder using grinding medium made of other than Fe.

3. The preparation method according to claim 1, wherein x≦1.0.

4. The preparation method according to any one of claims 1, wherein 30≦y≦80.

5. The preparation method according to any one of claims 1, wherein x×y≦30.

6. The preparation method according to any one of claims 2, wherein the temperature of hydrochloric acid or aqua regia is 60-100° C.

7. A polycrystalline silicon having a carrier lifetime of 5 μsec or more at a crystal surface contacted with a mold release agent.
